(19) United States
(12) Patent Application Publication
(10) Pub. No.: US 2012/0036070 A1
(43) Pub. Date: Feb. 9, 2012

(54) MODULAR TRANSACTIONAL BANKING PLATFORM

(75) Inventors: Daniel Goldman, Foxboro, MA (US); Geoff Thomas, Needham, MA (US)

(73) Assignee: CITIZENS FINANCIAL GROUP, INC., Providence, RI (US)

(21) Appl. No.: 13/157,666

(22) Filed: Jun. 10, 2011

Related U.S. Application Data
(60) Provisional application No. 61/353,298, filed on Jun. 10, 2010.

(51) Int. Cl. G06Q 40/02

(52) U.S. Cl. 705/42; 705/39

(57) ABSTRACT

A modular transactional banking platform is disclosed that separates the chassis of the account from all of the remaining optional package features, allowing users to select and customize the various components they wish to package into their account. The banking platform is constructed using a modular one-to-many approach that separates the “chassis” from the “features” in a manner that enables customers (and the bank) to create multiple account combinations and the flexibility to change as their needs adjust. The process of account creation may be completed in a self-service manner in an online environment or in person with the assistance of a banker. The features of the account are then attached to the account chassis as money applications or money applications in a customer selected bundle or al a carte fashion.

### CROSS-REFERENCE TO RELATED APPLICATIONS

This application claims priority from earlier filed U.S. Provisional Patent application No. 61/353,298, filed Jun. 10, 2010.

### BACKGROUND OF THE INVENTION

The present invention relates generally to a modular transactional banking platform that allows users to select and customize the various components they wish to package into their account. More specifically, the present invention relates to a modular transactional banking platform that separates the chassis of the account from all of the remaining optional package features.

Consumers today are looking for the ability to obtain full service package bundles for any services to which they subscribe. As these consumers become savvier regarding the features available to them and the packages being offered they tend to become more discriminating as to the services they purchase or subscribe to. Further, as more information about their current services as well as the available competitors' services is readily available to these consumers they have the opportunity to rapidly locate a new service provider should the current service provider not be a perfect fit.

In the service industry many service providers are offering customizable bundling of the services they provide. For example, telecommunications companies that provide television programming, telephone services and Internet access to residential customers offer a number of different means by which a customer can customize a package that fits their needs. A customer can select the volume and speed of their Internet connection, the features on their telephone line such as call waiting or forwarding and the various channel content that is available to them. In a similar fashion, in the mobile telephone industry, customers can select the number of voice minutes, text messages and the data volume for which they are willing to prepay as part of a customizable package.

In contrast, bank service providers still do not offer much more than the same well-known and basic account arrangements. For example, a banking service customer looking for a checking account may be provided with a debit card and/or online banking. There are no real options or additional features available to the customer, simply the basic underling account chassis with enhanced access. These systems, however, do not provide for the easy selection and implementation of various additional services offered by the bank service provider.

Accordingly, there is a need for a modular transactional banking platform that allows a customer to build an account employing the features that they will most use or that most appeal to them. There is a further need for a build-your-own style modular banking platform that allows a customer to bundle banking services as they are needed in order to provide greater financial control and customer value. Still further, there is a need for a modular transactional banking platform that separates the banking chassis from the banking features to create multiple banking account combinations while providing the customer the flexibility to adjust the packaging as their needs change.

### BRIEF SUMMARY OF THE INVENTION

In this regard, the present invention provides a modular transactional banking platform that allows users to select and customize the various components they wish to package into their account. More specifically, the present invention provides a modular transactional banking platform that separates the chassis of the account from all of the remaining optional package features. In the context of the present invention the banking platform is constructed using a modular one-to-many approach that separates the “chassis” from the “features” in a manner that enables customers (and the bank) to create multiple account combinations and the flexibility to change as their needs adjust. The process of account creation may be completed in a self-service manner in an online environment or in person with the assistance of a banker. The account begins with a basic banking system that the customer selects. The basis chassis of the system for example may include a checking account and savings account that has a debit card and online banking bill pay system attached thereto. Such a basic chassis may include bill reminders, mobile and text alerts, money transfers and live support/chat.

The features of the account are then attached to the account chassis as money applications or money applications in a customer selected bundle or al a carte fashion. In other words, each of the money applications may be applied to the chassis on an individual basis or in the context of a prepackaged bundle of applications. This allows a user the flexibility to add/remove additional features to their basic account as their needs change. On the service provider side new features can be packaged without the need for developing/cloning new product types and creates the opportunity for them to leverage “special” or “limited” features and bundles as promotional offers.

In the context of the present invention each of the money applications may be categorized wherein applications that serve like functions or that meet similar needs may be grouped. For example, categories may include loyalty, overdraft, protection, fun, etc. Money applications within these categories may include interest bonuses, ATM rebates, loan rate guarantees, identity protection, rewards programs, travel concierge as well as the many other possible money applications. Further, bundles are provided that are tailored to particular demographic groups' needs and may include student, travel, homebuyer, saver or any other bundle. These bundles include money applications that are targeted to the demographic described by the bundle itself.

In operation, a customer establishes a basic banking chassis. Standard customers then pay a transactional fee for this account. Then the customer selects various money applications for application to the basic account. These applications each are provided and have an additional fee but can be added to and removed front the account as needed. Still further the customer may elect from a bundle that provides a predetermined selection of money applications suited to their particular need or demographic.

It should also be appreciated that in the context of the present invention, a fee is established for the basic account, the various money applications and the bundled applications. The fee may be a singular fee that is paid for use of the feature. In a preferred embodiment, the fee is established as a fixed charge per month per money app or bundle. Further, the fee may be structure in a manner that different customers may be charged different or even no fees depending on the overall banking services that they use.

Accordingly, it is an object of the present invention to provide a modular transactional banking platform that allows a customer to build an account employing the features that they will most use or that most appeal to them. It is a further object of the present invention to provide a build-your-own style modular banking platform that allows a customer to bundle banking services as they are needed in order to provide greater financial control and customer value. It still a further object of the present invention to provide a modular transactional banking platform that separates the banking chassis from the banking features to create multiple banking account combinations while providing the customer the flexibility to adjust the packaging as their needs change.

### BRIEF DESCRIPTION OF THE DRAWINGS

In the drawings which illustrate the best mode presently contemplated for carrying out the present invention:

FIG. 1 is a schematic illustration of the modular transactional banking platform of the present invention;

FIG. 2 is an illustration of a modular structure for the transactional banking platform;

FIG. 3 is an illustration of possible modular bundles;

FIG. 4 is an illustration of possible applications within a given bundle;

FIG. 5 is an illustration of modular application categories; and

FIG. 6 is an illustration of modular applications.

### DETAILED DESCRIPTION OF THE INVENTION

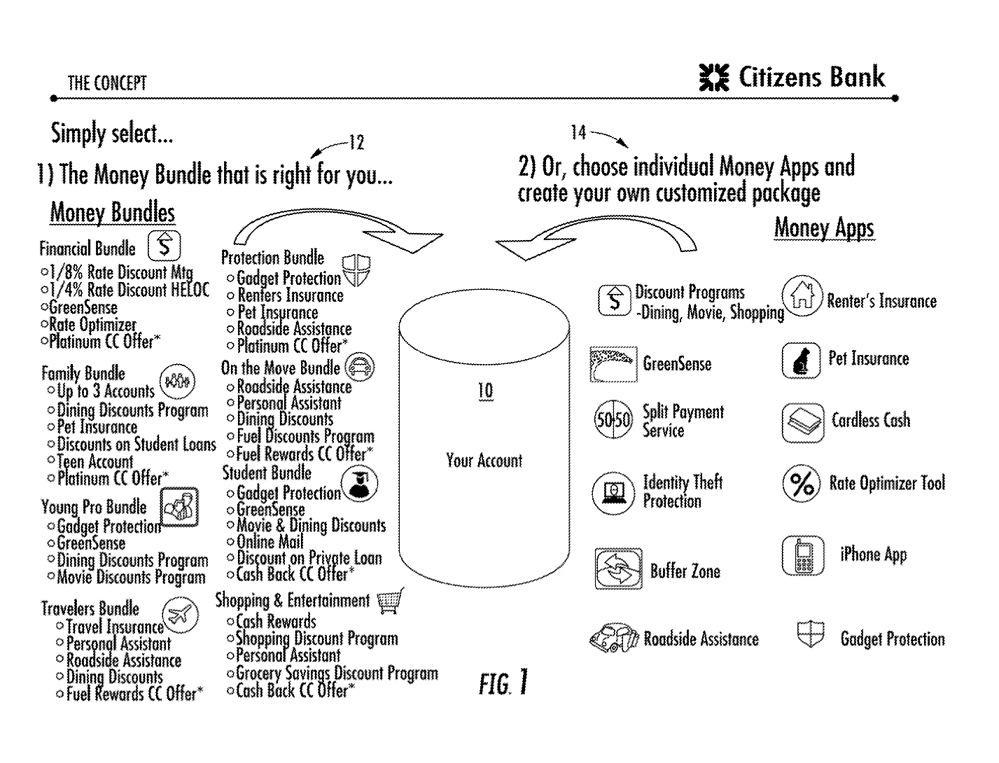

Now referring to the drawings, the present invention can be seen as a modular transactional banking platform that allows users to select and customize the various components they wish to package into their base traditional account. As can be seen in FIG. 1, the present invention provides a modular transactional banking platform that separates the basic chassis 10 of the account from all of the remaining optional package features. In the context of the present invention the banking platform is constructed using a modular one-to-many approach that separates the “chassis” 10 from the “features” including bundles 12 or money applications 14 in a manner that enables customers (and the bank) to create multiple account combinations and the flexibility to change as their needs adjust.

In the context of the present invention, the process of account creation is intended to be accomplished as is commonly already known in the art. The account creation may be completed in a self-service manner in an online environment or in person with the assistance of a banker. The account chassis 10 begins with a basic banking system that the customer selects. The basic chassis 10 of the system for example may include a checking account and savings account that has a debit card. Further a customer may add an online banking bill pay system. Such a basic chassis may also include bill reminders, mobile and text alerts, money transfers and live support/chat.

Any additional features of the account are then attached to the basic chassis 10 as individually selected money applications 14 or money applications that have been preconfigured into a customer selected money application bundle 12. In other words, each of the money applications 14 may be applied to the basic chassis 10 on an individual basis or in the context of a prepackaged bundle of money applications 12. This allows a user the flexibility to add/remove additional features to their basic account as their needs change. On the service provider side new features can be packaged without the need for developing/cloning new product types and creates the opportunity for them to leverage “special” or “limited” features and bundles as promotional offers.

In the context of a system and method of offering a bank account, a basic account chassis 10 is offered that is established and resides as a record or collection of records on a computer system that is established and maintained by the bank service provider wherein the account has been established. Such a computer system includes data and record storage means, computer processors and a connection to a remotely accessible network to facilitate the processing of transactions and to allow customer access thereto. A customer can in turn access the account record either by going to a bank service provider branch or through an access terminal such as a computer that is connected to the remotely accessible network.

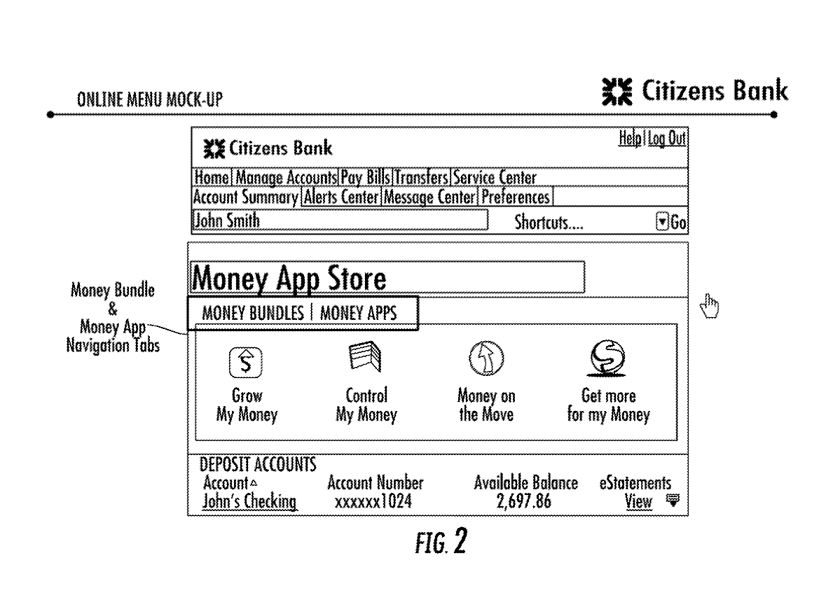

When making decisions and arranging the features for the account disclosed in the present application, as is depicted at FIG. 2, the customer enters a menu of available options relating to the basic chassis 10 of the account. The menu is configured and arranged as a Money Application Store or the like. Within the menu, the customer is presented with the variety of available money applications and the manner in which the customer can select the money applications for attachment to their account. This interface arrangement allows the customer full control over all of the modular features available for their account. As stated above, such features in the form of money applications may be arranged by category for al a carte selection, bundled or grouped in any other logical manner including, but not limited to, premium/non-premium, account holder tiers etc.

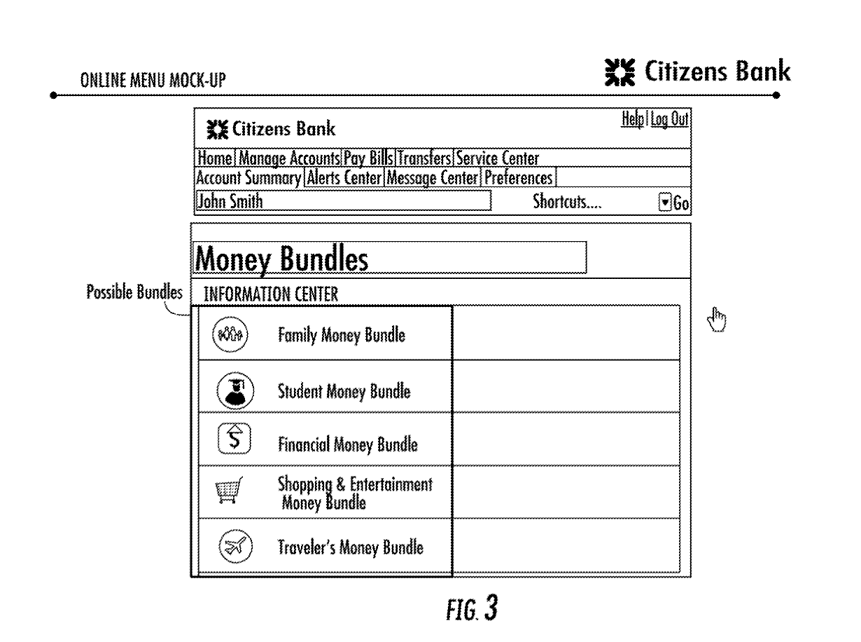

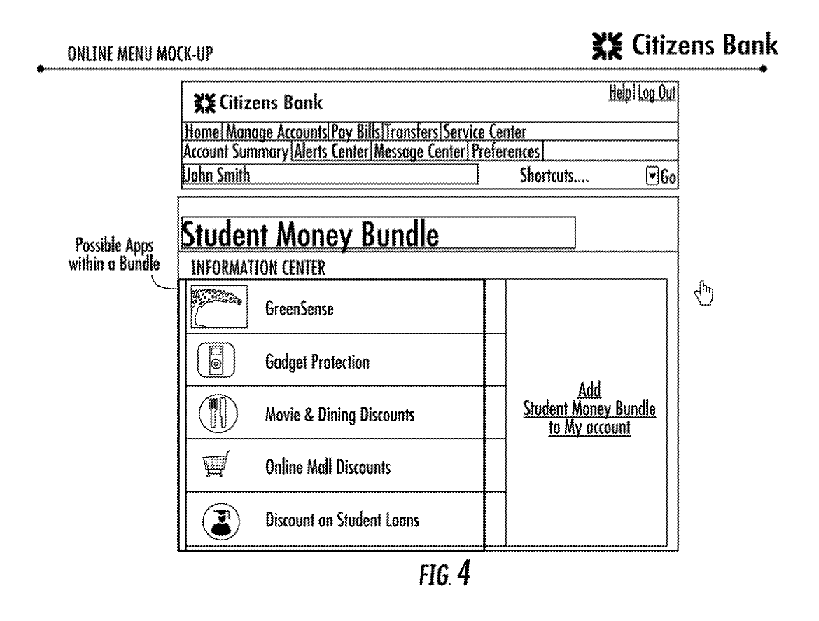

In the method and system of the present invention each of the money applications may be bundled as depicted at FIGS. 3 and 4. In this regard money applications that serve like functions or that meet similar needs may be grouped. Such bundles are tailored to particular demographic groups needs and may include student, travel, homebuyer, saver or any other bundle. These bundles include money applications that are targeted to the demographic described by the bundle itself. For example, the Student Money Bundle depicted at FIG. 4 is shown to include money applications such as GreenSense, Gadget Protection, which is insurance for electronics devices, and discount program such as for movies, dining, shopping and student loans. Other bundles that are tailored for other demographics may also include similar money applications if they are suited to the demographic or may be entirely different depending on the needs of the demographic being served.

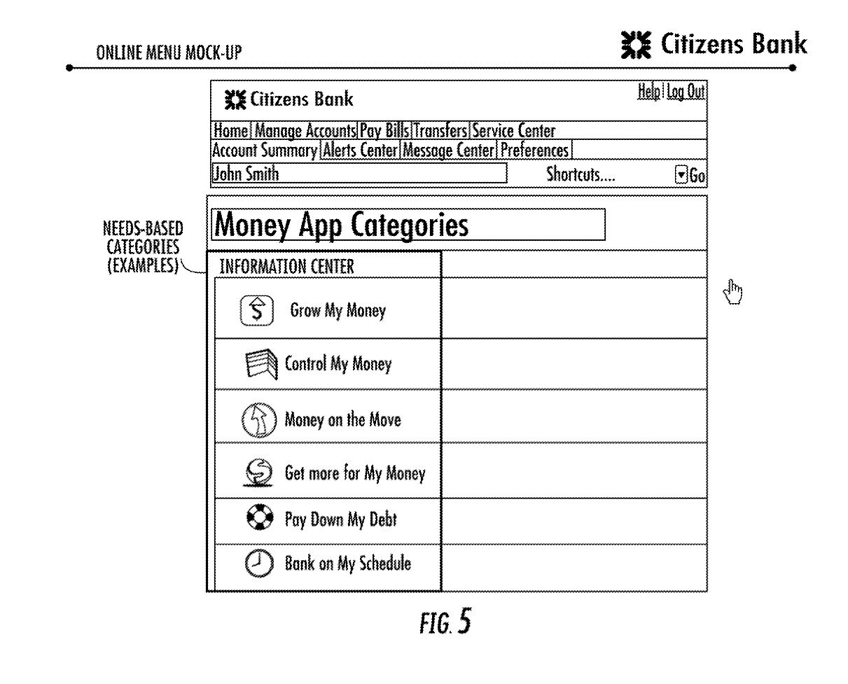

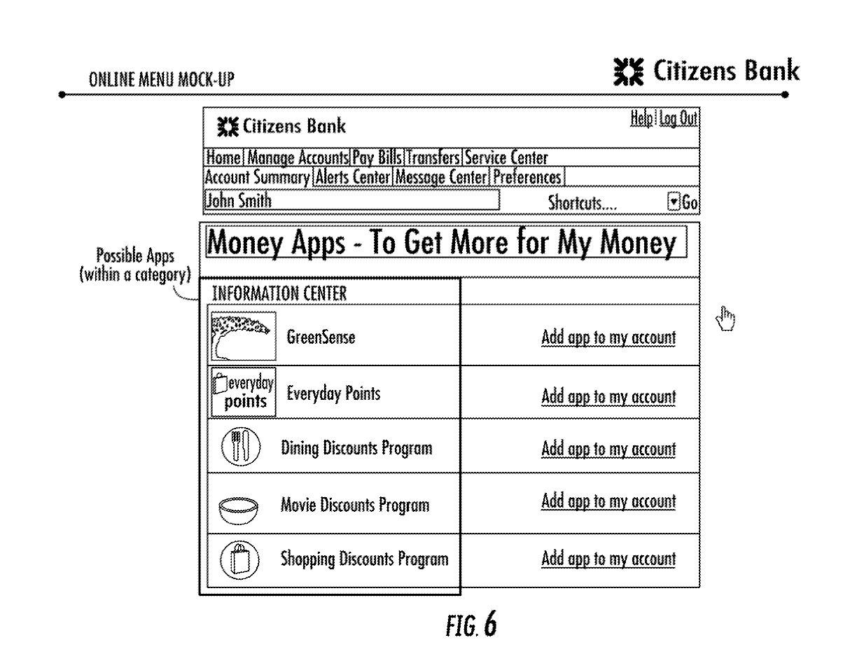

In addition to bundles, money applications may be arranged individually by category as depicted in FIGS. 5 and 6. For example, categories may include money applications that related to loyalty, overdraft, asset protection, fun, etc. As depicted the categories are related to growth, movement and control of money as well as discounts, banking features and debt payment. Money applications within these categories may include interest bonuses, ATM rebates, loan rate guarantees, identity protection, rewards programs, travel concierge as well as the many other possible money applications.

In operation, a customer establishes a basic banking chassis. A payment system for the establishment of such a banking chassis may be established and further may be tiered such that standard customers pay a transactional fee for this account while account holders meeting certain thresholds for deposits may not pay a fee or pay a reduced fee. Then the customer selects various money applications for application to the basic account. These applications each may have an additional fee but can be added to and removed front the account as needed. Still further the customer may elect from a bundle that provides a predetermined selection of money applications suited to their particular need or demographic. For example, categories may include loyalty, overdraft, protection, fun, etc. Money applications within these categories may include interest bonuses, ATM rebates, loan rate guarantees, identity protection, rewards programs, travel concierge as well as the many other possible money applications.

It should also be appreciated that in the context of the present invention, a fee is established for the basic account, the various money applications and the bundled applications. The fee may be a singular fee that is paid for use of the feature. In a preferred embodiment, the fee is established as a fixed charge per month per money app or bundle. Further, the fee may be structure in a manner that different customers may be charged different or even no fees depending on the overall banking services that they use.

It can therefore be seen that the present invention provides a modular transactional banking platform that allows a customer to build an account employing the features that they will most use or that most appeal to them. Further, the present invention provides a build-your-own style modular banking platform that allows a customer to bundle banking services as they are needed in order to provide greater financial control and customer value in a manner that separates the banking chassis from the banking features to create multiple banking account combinations while providing the customer the flexibility to adjust the packaging as their needs change. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of providing a transactional bank account:
establishing a banking chassis, said banking chassis including at least a checking account;
providing a plurality of user selectable money applications that can be applied to said banking chassis, wherein a user selects one or more of said money applications for use in said banking chassis.

2. The method of claim 1, wherein said money applications are a variety of modular features for use in said transactional bank account.

3. The method of claim 1, wherein a user can select money applications for use in their transactional bank account in an al a carte fashion.

4. The method of claim 1, wherein said money applications are arranged by categories relating to their functionality.

5. The method of claim 4, wherein said categories are selected from the group consisting of: loyalty, overdraft, asset protection, fun, growth, movement and control of money, discounts, banking features and debt payment

6. The method of claim 1, wherein a user can select from a plurality of prebundled money applications.

7. The method of claim 6, wherein said money applications are prebundled based on target demographics of user groups.

8. The method of claim 1, wherein a fee is charged for each money application selected for use in the transactional bank account.

9. The method of claim 1, wherein a user accesses said transactional banking account through an online interface to add or remove money applications relative to the banking chassis.

10. A transactional bank account comprising:
a banking chassis, said banking chassis including at least a checking account;
a plurality of user selectable money applications that can be applied to said banking chassis, wherein a user selects one or more of said money applications for use in said banking chassis.

11. The transactional bank account of claim 10, wherein said money applications are a variety of modular features for use in said transactional bank account.

12. The transactional bank account of claim 10, wherein a user can select money applications for use in their transactional bank account in an al a carte fashion.

13. The transactional bank account of claim 10, wherein said money applications are arranged by categories relating to their functionality.

14. The transactional bank account of claim 13, wherein said categories are selected from the group consisting of: loyalty, overdraft, asset protection, fun, growth, movement and control of money, discounts, banking features and debt payment

15. The transactional bank account of claim 10, wherein a user can select from a plurality of prebundled money applications.

16. The transactional bank account of claim 15, wherein said money applications are prebundled based on target demographics of user groups.

17. The transactional bank account of claim 10, wherein a fee is charged for each money application selected for use in the transactional bank account.

18. The transactional bank account of claim 10, wherein a user accesses said transactional banking account through an online interface to add or remove money applications relative to the banking chassis.
